(19) United States
(12) Patent Application Publication
(10) Pub. No.: US 2017/0066654 A1
(43) Pub. Date: Mar. 9, 2017

(54) HIGH-PURITY SILICON DIOXIDE GRANULES FOR QUARTZ GLASS APPLICATIONS AND METHOD FOR PRODUCING SAID GRANULES

(71) Applicant: Evonik Degussa GmbH, Essen (DE)

(72) Inventors: Christian Panz, Wesseling-Berzdorf (DE); Guido Titz, Heimbach (DE); Sven Müller, Bonn (DE); Markus Ruf, Alfter-Witterschlick (DE); Bodo Frings, Schloss Holte (DE); Hartwig Rauleder, Rheinfelden (DE); Jürgen Behnisch, Rheinbach (DE)

(21) Appl. No.: 15/295,899

(22) Filed: Oct. 17, 2016

Related U.S. Application Data
(62) Division of application No. 14/000,954, filed on Nov. 27, 2013, now abandoned.

(30) Foreign Application Priority Data
Feb. 22, 2011 (DE) 102011004532.5

(51) Int. Cl. C01B 33/193; C03B 19/10; C03C 1/02

(52) U.S. Cl. CPC C01B 33/193; C03C 1/022; C03B 19/1065; C03B 19/1095; C01P 2006/80; C01P 2004/60

(57) ABSTRACT

It has been found that conventional cheap waterglass qualities in a strongly acidic medium react to give high-purity silica grades, the treatment of which with a base leads to products which can be processed further to give glass bodies with low silanol group contents.

### CROSS-REFERENCE TO RELATED APPLICATIONS

This patent application is a divisional of and claims priority to U.S. patent application Ser. No. 14/000,954, filed Nov. 27, 2013, which is a national stage filing under 35 U.S.C. 371 of International Application No. PCT/EP2012/052251, filed on Feb. 10, 2012, which claims the benefit of priority to German Patent Application No. 102011004532.5, filed on Feb. 22, 2011, the disclosures of which are incorporated by reference herein in their entireties. Priority to each application is hereby claimed.

### FIELD OF THE INVENTION

The invention relates to high-purity silica granules, to a process for production thereof and to the use thereof for quartz glass applications.

### BACKGROUND

Particular glass applications and especially quartz glass applications require a high purity of the silica used, combined with minimum contents of bubbles or OH groups in the finished glass product.

There are numerous known methods for production of granules proceeding from amorphous silica. Suitable starting materials may be silica produced by sol-gel processes, precipitated silica or a fumed silica. The production usually comprises agglomeration of the silica. This can be effected by means of wet granulation. In the case of wet granulation, a sol is produced from a colloidal silica dispersion by constant mixing or stirring, and crumbly material is produced therefrom with gradual withdrawal of the moisture. Production by means of wet granulation is inconvenient and costly, especially when high demands are made on the purity of the granules.

It is additionally possible to obtain granules by compaction of silica. Binder-free compaction of fumed silica is difficult because fumed silica is very dry, and there are no capillary forces to bring about particle binding. Fumed silicas are notable for extreme fineness, low bulk density, high specific surface area, very high purity, very substantially spherical primary particle shape, and lack of pores. The fumed silica frequently has high surface charge, which makes agglomeration more difficult for electrostatic reasons.

Nevertheless, compaction of fumed silica, for the lack of alternatives, has to date constituted the preferred way of producing silica granules, also called silica glasses.

U.S. Pat. No. 4,042,361 discloses a process for producing silica glass, in which fumed silica is used. The latter is incorporated into water to form a castable dispersion, then the water is removed thermally, and the fragmented residue is calcined at 1150 to 1500° C. and then ground into granules of 1-100 μm in size and vitrified. The purity of the silica glass thus produced is insufficient for modern-day applications. The production process is inconvenient and costly.

WO91/13040 also discloses a process in which fumed silica is used to produce silica glass. The process comprises the provision of an aqueous dispersion of fumed silica with a solids content of about 5 to about 55% by weight, the conversion of the aqueous dispersion to porous particles by drying it in an oven at a temperature between about 100° C. and about 200° C., and comminuting the porous residue. This is followed by sintering of the porous particles in an atmosphere with a partial steam pressure in the range from 0.2 to 0.8 atmosphere at temperatures below about 1200° C. High-purity silica glass granules are obtained with a particle diameter of about 3 to 1000 μm, a nitrogen BET surface area of less than about 1 m²/g and a total content of impurities of less than about 50 ppm, the content of metal impurity being less than 15 ppm.

EP-A-1717202 discloses a process for producing silica glass granules, in which a fumed silica which has been compacted by a particular process to tamped densities of 150 to 800 g/l is sintered. The compaction in question, disclosed in DE-A-19601415, is a spray-drying operation on silica dispersed in water with subsequent heat treatment at 150 to 1100° C. The granules thus obtained can be sintered, but do not give bubble-free silica glass granules.

Also known are processes for producing silica granules which originate from sol-gel processes.

EP-A-1258456 discloses, for example, a process for producing a monolithic glass body, in which a silicon alkoxide is hydrolysed and then a fumed silica powder is added to form a sol; the sol formed is then converted to a gel, which is dried and finally sintered.

Processes likewise based on sol-gel processes, in which silicon alkoxides and fumed silica powder are used, are disclosed by the document EP-A-1283195.

In principle, the latter processes all follow the same pattern. First, an alkoxide is hydrolysed to give silica with formation of a sol which is converted to a gel which is dried and finally sintered. The processes in question comprise several stages, and are laborious, sensitive with regard to process variations and prone to impurities. An additional factor is that, in the case of the products obtainable by sol-gel processes, relatively high amounts of troublesome silanol groups remain in the finished glass body and lead to the formation of unwanted bubbles therein.

Production using chlorosilanes, which is likewise possible, has the disadvantage that elevated concentrations of chlorine groups occur in the glass, which are intolerable for particular fields of use of quartz glass products. The residues of organic radicals of alkyl- or arylsilanes can also lead to problems in the finished glass body, such as black spots or bubble formation. In the case of such silica qualities, the carbon content has to be reduced by a complex oxidative treatment (for example described in DE69109026), and the silanol group content with corrosive chlorinating agents in an energy-intensive and costly manner (described, for example, in U.S. Pat. No. 3,459,522).

In the case of very high purity demands, it is possible in principle to use hydrothermal silica. The growth rate of these quartz qualities is, however, so low that the costs for the intended quartz glass applications are unacceptable.

The use of particular processed natural quartzes, for example of IOTA quality from Unimin, ensures high purities and low silanol group contents, but there are very few deposits globally which possess sufficiently high quality. The limited supply situation leads to high costs, which are likewise unacceptable for standard quartz glass applications.

It was therefore an object of the present invention to provide high-purity silica granules for quartz glass applications and an inexpensive process for production thereof.

It was a further object of the present invention to ensure that the granules in question and the products obtainable with them are suitable for quartz glass applications; in this context, a low content of silanol groups is a particular requirement since this crucially influences the degree of unwanted bubble formation in the course of production of the glass body.

The research studies in question found that conventional cheap waterglass qualities react in a strongly acidic medium to give high-purity silica types, the treatment of which with a base leads to products which can be processed further to give glass bodies with low silanol group contents.

### SUMMARY OF THE INVENTION

The aforementioned objects, and further objects which are evident from the prior art, are achieved by the novel high-purity silica types according to claim 1, and by a process according to claim 14. Advantageous embodiments and configurations of the invention can be inferred from the dependent claims and the description.

### DETAILED DESCRIPTION

The invention can be divided into process steps a. to j., though not all process steps need necessarily be performed; more particularly, the drying of the silica obtained in step c. (step f.) can optionally be dispensed with. An outline of the process according to the invention can be given as follows:
a. preparing an initial charge of an acidifier with a pH of less than 2.0, preferably less than 1.5, more preferably less than 1.0, most preferably less than 0.5
b. providing a silicate solution, it being possible to establish especially the viscosity for preparation of the silicon oxide purified by precipitation advantageously within particular viscosity ranges;

preference is given especially to a viscosity of 0.1 to 10 000 poise, though this viscosity range can be widened further according to the process regime - as detailed below—as a result of further process parameters
c. adding the silicate solution from step b. to the initial charge from step a. in such a way that the pH of the resulting precipitation suspension is always below 2.0, preferably below 1.5, more preferably below 1.0 and most preferably below 0.5
d. removing and washing the resulting silica, the wash medium having a pH less than 2.0, preferably less than 1.5, more preferably less than 1.0 and most preferably less than 0.5
e. washing the silica to neutrality with demineralized water until the conductivity thereof has a value of below 100 μS, preferably of below 10 μS
f. drying the resulting silica
g. treating the silica with a base
h. washing the silica with demineralized water, drying and comminuting the dried residue
i. sieving the resulting silica granules to a particle size fraction in the range of 200-1000 μm, preferably of 200-600 μm, more preferably of 200-400 μm and especially of 250-350 μm
j. sintering the silica fraction at at least 600° C., preferably at at least 1000° C. and more preferably at at least 1200° C.

According to the invention, the medium referred to hereinafter as precipitation acid, into which the silicon oxide dissolved in aqueous phase, especially a waterglass solution, is added dropwise in process step c., must always be strongly acidic. “Strongly acidic” is understood to mean a pH below 2.0, especially below 1.5, preferably below 1.0 and more preferably below 0.5. The aim may be to monitor the pH in the respect that the pH does not vary too greatly to obtain reproducible products. If a constant or substantially constant pH is the aim, the pH should exhibit only a range of variation of plus/minus 1.0, especially of plus/minus 0.5, preferably of plus/minus 0.2.

Acidifiers used with preference as precipitation acids are hydrochloric acid, phosphoric acid, nitric acid, sulphuric acid, chlorosulphonic acid, sulphuryl chloride, perchloric acid, formic acid and/or acetic acid, in concentrated or dilute form, or mixtures of the aforementioned acids. Particular preference is given to the aforementioned inorganic acids, i.e. mineral acids, and among these especially to sulphuric acid.

Repeated treatment of the precipitation product with (precipitation) acid, i.e. repeated acidic washing of the precipitation product, is preferred in accordance with the invention. The acidic washing can also be effected with different acids of different concentration and at different temperatures. The temperature of the acidic reaction solution during the addition of the silicate solution or of the acid is kept by heating or cooling at 20 to 95° C., preferably at 30 to 90° C., more preferably at 40 to 80° C.

Wash media may preferably be aqueous solutions of organic and/or inorganic water-soluble acids, for example of the aforementioned acids or of fumaric acid, oxalic acid or other organic acids known to those skilled in the art which do not themselves contribute to contamination of the purified silicon oxide because they can be removed completely with high-purity water. Generally suitable are therefore aqueous solutions of all organic (water-soluble) acids, especially consisting of the elements C, H and O, both as precipitation acids and as wash media if they do not themselves lead to contamination of the silicon oxide.

The wash medium may if required also comprise a mixture of water and organic solvents. Appropriate solvents are high-purity alcohols such as methanol, ethanol, propanol or isopropanol.

In the process according to the invention, it is normally unnecessary to add chelating agents in the course of precipitation or of acidic purification. Nevertheless, the present invention also includes, as a particular embodiment, the removal of metal impurities from the precipitation or wash acid undertaken using complexing agents, for which the complexing agents are preferably—but not necessarily—used immobilized on a solid phase. One example of a metal complexing agent usable in accordance with the invention is EDTA (ethylenediaminetetraacetate). It is also possible to add a peroxide as an indicator or colour marker for unwanted metal impurities. For example, hydroperoxides can be added to the precipitation suspension or to the wash medium in order to identify any titanium impurities present by colour.

The aqueous silicon oxide solution is an alkali metal and/or alkaline earth metal silicate solution, preferably a waterglass solution. Such solutions can be purchased commercially or prepared by dissolving solid silicates. In addition, the solutions can be obtained from a digestion of silica with alkali metal carbonates or prepared via a hydrothermal process at elevated temperature directly from silica, alkali metal hydroxide and water. The hydrothermal process may be preferred over the soda or potash process because it can lead to purer precipitated silicas. One disadvantage of the hydrothermal process is the limited range of moduli obtainable; for example, the modulus of SiO₂ to Na₂O is up to 2, preferred moduli being 3 to 4; in addition, the waterglasses after the hydrothermal process generally have to be concentrated before any precipitation. In general terms, the preparation of waterglass is known as such to the person skilled in the art.

In a specific embodiment, an aqueous solution of waterglass, especially sodium waterglass or potassium waterglass, is filtered before the inventive use and then, if necessary, concentrated. Any filtration of the waterglass solution or of the aqueous solution of silicates to remove solid, undissolved constituents can be effected by known processes and using apparatuses known to those skilled in the art.

The silicate solution before the acidic precipitation has a silica content of preferably at least 10% by weight. According to the invention, a silicate solution, especially a sodium waterglass solution, is used for acidic precipitation, the viscosity of which is 0.1 to 10 000 poise, preferably 0.2 to 5000 poise, more preferably 0.3 to 3000 poise and most preferably 0.4 to 1000 poise (at room temperature, 20° C.).

To conduct the precipitation, a high-viscosity waterglass solution is preferably added to an acidifier, which forms an acidic precipitation suspension. In a particular embodiment of the process according to the invention, silicate or waterglass solutions whose viscosity is about 5 poise, preferably more than 5 poise, are used (at room temperature, 20° C.).

In a further specific embodiment, silicate or waterglass solutions whose viscosity is about 2 poise, preferably less than 2 poise, are used (at room temperature, 20° C.).

The silicon oxide or silicate solutions used in accordance with the invention preferably have a modulus, i.e. a weight ratio of metal oxide to silica, of 1.5 to 4.5, preferably 1.7 to 4.2 and more preferably 2.0 to 4.0.

A variety of substances are usable in process step g. for basic treatment of the silica. Preference is given to using bases which are either themselves volatile or have an elevated vapour pressure compared to water at room temperature, or which can release volatile substances. Preference is further given to bases containing elements of main group 5 of the Periodic Table of the chemical elements, especially nitrogen bases and among these very particularly ammonia. Additionally usable in accordance with the invention are substances or substance mixtures which comprise at least one primary and/or secondary and/or tertiary amine. In general, basic substance mixtures can be used in a wide variety of different compositions, and they preferably contain at least one nitrogen base.

Preferably, but not necessarily, the basic treatment is effected at elevated temperature and/or elevated pressure.

The apparatus configuration used to perform the different process steps is of minor importance in accordance with the invention. What is important in the selection of the drying devices, filters, etc. is merely that contamination of the silica with impurities in the course of the process steps is ruled out. The units which can be used for the individual steps given this proviso are sufficiently well known to the person skilled in the art and therefore do not require any further explanations; preferred materials for components or component surfaces (coatings) which come into contact with the silica are polymers stable under the particular process conditions and/or quartz glass.

The novel silica granules are notable in that they have alkali metal and alkaline earth metal contents between 0.01 and 10.0 ppm, a boron content between 0.001 and 1.0 ppm, a phosphorus content between 0.001 and 1.0 ppm, a nitrogen pore volume between 0.01 and 1.5 ml/g and a maximum pore dimension between 5 and 500 nm, preferably between 5 and 200 nm. The nitrogen pore volume of the silica granules is preferably between 0.01 and 1.0 ml/g and especially between 0.01 and 0.6 ml/g.

The further analysis of the inventive granules showed that the carbon content thereof is between 0.01 and 40.0 ppm and the chlorine content thereof between 0.01 and 100.0 ppm; ppm figures in the context of the present invention are always the parts by weight of the chemical elements or structural units in question.

For the further processing of the silica granules, suitable particle size distributions are between 0.1 and 3000 μm, preferably between 10 and 1000 μm, more preferably between 100 and 800 μm. In a preferred but non-obligatory embodiment, the further processing is effected in such a way that the granules are melted by a heating step in the presence of a defined steam concentration, which is preferably at first relatively high and is then reduced, to give a glass body with a low level of bubbles.

The inventive high-purity silica granules can be used for a variety of applications, for example for the production of quartz tubes and quartz crucibles, for the production of optical fibres and as fillers for epoxide moulding compositions. The inventive products can also be used to ensure good flow properties and high packing densities in moulds for quartz crucible production; these product properties can also be useful to achieve high solids loadings in epoxide moulding compositions. The inventive silica granules have alkali metal or alkaline earth metal contents of below 10 ppm in each case and are characterized by small nitrogen pore volumes of below 1 ml/g.

Especially in the particle size range of 50-2000 μm, the products surprisingly sinter to give virtually bubble-free glass bodies with silanol group contents below 150 ppm in total. The products in question preferably have silanol group contents (parts by weight of the silicon-bonded OH groups) between 0.1 and 100 ppm, more preferably between 0.1 and 80 ppm and especially between 0.1 and 60 ppm.

Otherwise, the production of these high-quality glass bodies is possible without any need for any kind of treatment with chlorinating agents and also dispenses with the use of specific gases in the thermal treatment, such as ozone or helium.

The inventive silica granules are therefore outstandingly suitable as raw materials for production of shaped bodies for quartz glass applications of all kinds, i.e. including high-transparency applications. More particularly, the suitability includes the production of products for the electronics and semiconductor industries and the manufacture of glass or light waveguides. The silica granules are additionally very suitable for the production of crucibles, and particular emphasis is given to crucibles for solar silicon production.

Further preferred fields of use for the inventive high-purity silica granules are high-temperature-resistant insulation materials, fillers for polymers and resins which may have only very low radioactivities, and finally the raw material use thereof in the production of high-purity ceramics, catalysts and catalyst supports.

The invention is described hereinafter by examples, though this description is not intended to give rise to any restriction with regard to the range of application of the invention:

1.) Preparation of the Silica According to Process Steps a.-f.

1800 litres of 14.1% sulphuric acid were initially charged and 350 litres of an aqueous 37/40 waterglass solution (density=1350 kg/m³, Na₂O content=8%, SiO₂ content=26.8%, %SiO₂/%Na₂O modulus=3.35) were added to this initial charge with pump circulation within one hour. In the course of addition, millimetre-size prills formed spontaneously, which formed a pervious bed and enabled, during the continued addition of waterglass, pumped circulation of the contents of the initial charge through a sieve plate at 800 litres/hour and permanent homogenization of the liquid phase.

The temperature should not exceed a value of 35° C. during the addition of the waterglass solution; if required, compliance with this maximum temperature must be ensured by cooling the initial charge. After complete addition of waterglass, the internal temperature was raised to 60° C. and kept at this value for one hour, before the synthesis solution was discharged through the sieve plate.

To wash the product obtained, the initial charge was supplemented with 1230 litres of 9.5% sulphuric acid at 60° C. within approx. 20 minutes, which was pumped in circulation for approx. 20 minutes and discharged again. This washing operation was subsequently repeated three times more with sulphuric acid at 80° C.; first with 16% and then twice more with 9% sulphuric acid. Finally, the procedure was repeated four times more in the same way with 0.7% sulphuric acid at 25° C., and then washing with demineralized water was continued at room temperature until the wash water had a conductivity of 6 μS. Drying of the high-purity silica obtained is optional.

2.) Preparation of the Silica Granules According to Process Steps g.-j.

### EXAMPLE 1

500 g of the moist silica prepared by the process described above (solids content 23.6%) were admixed in a 5 litre canister with 500 g of demineralized water and 50 g of a 25% ammonia solution. After shaking vigorously, this mixture with the lid screwed on was left to age in a drying cabinet overnight; the temperature during the alkaline ageing process was 80° C. The next day, the product was transferred into a 3000 ml beaker (quartz glass) and washed a total of five times with 500 ml of demineralized water each time, followed by decanting off; subsequently, the product in the beaker (quartz glass) was dried overnight in a drying cabinet heated to 160° C. The dry product was comminuted and sieved off to a fraction of 250-350 μm. 20 g of this fraction were heated in a 1000 ml beaker (quartz glass) to 1050° C. in a muffle furnace within four hours and kept at this temperature for one hour; it was cooled gradually by leaving it to stand in the furnace.

A further 20 g of the aforementioned sieve fraction were subjected to sintering at 1250° C.—under otherwise identical conditions. The BET surface areas and the pore volumes of the two sintered products and the material obtained after the drying cabinet drying were measured; in addition, glass rods were fused from these materials, all three of which had a high transparency and a low bubble content.

| | BET | BET | PV | PV |
|---|---|---|---|---|
| | measure- | measure- | measure- | measure- |
| | ment 1 | ment 2 | ment 1 | ment 2 |
| | [m²/g] | [m²/g] | [cc/g] | [cc/g] |
| Starting material | 795 | 823 | 0.510 | 0.528 |
| After NH₃ and | 131 | 131 | 0.464 | 0.439 |
| 160° C. treatment | | | | |
| After 1050° C. | 81.2 | 80.4 | 0.269 | 0.274 |
| treatment | | | | |
| After 1250° C. | 0.1 | 0.0 | 0.006 | 0.007 |
| treatment | | | | |

### EXAMPLE 2

2000 g of the moist silica prepared by the process described above (solids content 35%) were admixed in a 5 litre canister with 2000 g of demineralized water and 20 g of a 25% ammonia solution. After shaking vigorously, this mixture with the lid screwed shut was left to age overnight in a drying cabinet; the temperature during the alkaline ageing process was 80° C. The next day, the product was transferred into a 5000 ml beaker (quartz glass) and washed a total of three times with 1000 ml each time of demineralized water, followed by decanting off; subsequently, the product was dried in a porcelain dish in a drying cabinet heated to 160° C. overnight. This procedure was repeated several times in order to obtain a yield of more than 2000 g. The dry product was crushed in a 3000 ml quartz glass beaker with a quartz glass flask and sieved off to a fraction of 125-500 μm.

600 g of the fraction were heated in a 3000 ml quartz glass beaker to 600° C. in a muffle furnace within eight hours and held at this temperature for four hours before being left to cool overnight. The next day, the same sample was heated to 1200° C. within eight hours and held at this temperature for a further four hours; the cooling was again effected overnight. After the sintered product had been comminuted, it was filtered once again through a 500 μm sieve.

The BET surface areas and the pore volumes both of this sintered material and of the product being merely dried in a drying cabinet were measured; a glass rod was also fused from each of the products. In addition, a silanol group determination by IR spectroscopy was conducted on the sintered material. The values reported in silanol group determinations always correspond to the content of silicon-bonded OH groups in ppm (by weight).

| | BET | PV | Silanol | | Silanol |
|---|---|---|---|---|---|
| | measure- | measure- | group | | group |
| | ment | ment | content | | content |
| | [m²/g] | [cc/g] | (granules) | | (glass rod) |
| Starting | 828 | 0.545 | 77 400 | ppm | not |
| material | | | | | determinable |
| After NH₃ | 149 | 0.492 | — | | 82 ppm |
| and 160° C. | | | | | |
| treatment | | | | | |
| After 1200° C. | 0.1 | 0.004 | 395 | ppm | 85 ppm |

treatment

### COMPARATIVE EXAMPLE

A portion of the moist silica used in Example 2 (solids content 35%), after gentle drying at 50° C., was used to produce a fraction of 125-500 μm of the material by means of vibratory sieving, which was fused to a glass rod without the inventive treatment. The attempt to measure the silanol group content failed in this case because of the high bubble content of the glass rod, i.e. the intransparency caused thereby.

Production of the Glass Rods for Determination of the Silanol Group Contents:

The silica granules to be fused are introduced into a glass tube fused at one end and evacuated under high vacuum. Once a stable vacuum has been established, the glass rod is fused at least 20 cm above the granule level. Subsequently, the powder in the tube is melted with a hydrogen/oxygen gas burner to give a glass rod. The glass rod is cut into slices of thickness approx. 5 mm and the plane-parallel end faces are polished to a shine. The exact thickness of the glass slices is measured with a slide rule and included in the evaluation. The slices are clamped in the beam path of an IR measuring instrument. The IR spectroscopy determination of the silanol group content is not effected in the edge region of the slice since this consists of the material of the glass tube enveloping the fusion material.

Determination of the BET Surface Area and of the Nitrogen Pore Volume:

The specific nitrogen surface area (BET surface area) is determined to ISO 9277 as the multipoint surface area.

To determine the pore volume, the measuring principle of nitrogen sorption at 77 K, i.e. a volumetric method, is employed; this process is suitable for mesoporous solids with a pore diameter of 2 nm to 50 nm.

First, the amorphous solids are dried in a drying cabinet. The sample preparation and the measurement are effected with the ASAP 2400 instrument from Micromeritics, using nitrogen 5.0 or helium 5.0 as the analysis gases and liquid nitrogen as the cooling bath. Starting weights are measured on an analytic balance with an accuracy of 1/10 mg.

The sample to be analysed is predried at 105° C. for 15-20 hours. 0.3 g to 1.0 g of the predried substance is weighed into a sample vessel. The sample vessel is attached to the ASAP 2400 instrument and baked out at 200° C. under vacuum for 60 minutes (final vacuum <10 pm Hg). The sample is allowed to cool to room temperature under reduced pressure, blanketed with nitrogen and weighed. The difference from the weight of the nitrogen-filled sample vessel without solids gives the exact starting weight. The measurement is effected in accordance with the operating instructions of the ASAP 2400 instrument.

For evaluation of the nitrogen pore volume (pore diameter <50 nm), the adsorbed volume is determined using the desorption branch (pore volume for pores with a pore diameter of <50 nm).

1. A process for producing a glass product, comprising:
adding a silicate solution with a viscosity of 0.1 to 10 000 poise to an initial charge which comprises an acidifier and has a pH of less than 2.0, with the proviso that the pH during the adding is always below 2.0,
obtaining silica from the solution and subsequently treating the silica at least once with an acidic wash medium with a pH below 2.0,
subsequently washing the silica to neutrality and treating the silica with a base,
removing a particle size fraction in the range of 200-1000 μm and sintering the particle size fraction at a temperature of at least 600° C. to form high-purity silica granules comprising an alkali metal content between 0.01 and 10.0 ppm, an alkaline earth metal content between 0.01 and 10.0 ppm, a boron content between 0.001 and 1.0 ppm, a phosphorus content between 0.001 and 1.0 ppm, a nitrogen pore volume between 0.01 and 1.5 ml/g, and a maximum pore dimension between 5 and 500 nm, and
heating the high-purity silica granules to form a glass product having a content of silicon-bonded OH groups between 0.1 and 150 ppm.

2. The process according to claim 1, wherein the pH of the initial charge comprising the acidifier is less than 1.5.

3. The process according to claim 1, wherein the pH of the initial charge comprising the acidifier is less than 1.0.

4. The process according to claim 1, wherein the pH of the initial charge comprising the acidifier is less than 0.5.

5. The process according to claim 1, wherein the viscosity of the silicate solution is 0.4 to 1000 poise.

6. The process according to claim 1, wherein the viscosity of the silicate solution is more than 5 poise.

7. The process according to claim 1, wherein the viscosity of the silicate solution is less than 2 poise.

8. The process according to claim 1, wherein the pH during the addition of the silicate solution is always below 1.5 and the pH of the wash medium is likewise below 1.5.

9. The process according to claim 1, wherein the pH during the addition of the silicate solution is always below 1.0 and the pH of the wash medium is below 1.0.

10. The process according to claim 1, wherein the pH during the addition of the silicate solution is always below 0.5 and the pH of the wash medium is -below 0.5.

11. The process according to claim 1, wherein washing the silica to neutrality is performed with demineralised water until the demineralized water has a conductivity of below 100 μS, preferably below 10 μS.

12. The process according to claim 1, wherein the base is a nitrogen base.

13. The process according to claim 12, wherein the nitrogen base is ammonia.

14. The process according to claim 12, wherein the nitrogen base—comprises a primary amine, a secondary amine, a tertiary amine or a combination thereof.

15. The process according to claim 1, wherein subjecting the silica to a basic treatment is effected at elevated temperature, elevated pressure or a combination thereof.

16. The process according to claim 1, wherein the silica is washed, dried and comminuted after subjecting the silica to a basic treatment.

17. The process according to claim 1, wherein a particle size fraction in the range of 200-600 μm is removed.

18. The process according to claim 11, wherein a particle size fraction in the range of 200-400 μm is removed.

19. The process according to claim 1, wherein a particle size fraction in the range of 250-350 μm is removed.

20. The process according to claim 1, wherein the particle size fraction is sintered at a temperature of at least 1000° C.

21. The process according to claim 1, wherein the particle size fraction is sintered at a temperature of at least 1200° C.

22. The process according to claim 1, wherein the glass product comprises an impurity-sensitive quartz glass product.

23. The process according to claim 1, wherein the glass product comprises a content of silicon-bonded OH groups between 0.1 and 80 ppm.

24. The process according to claim 1, wherein the glass product comprises a content of silicon-bonded OH groups between 0.1 and 60 ppm.
